(19) United States
(12) Patent Application Publication
(10) Pub. No.: US 2010/0043301 A1
(43) Pub. Date: Feb. 25, 2010

(54) Water-based cutting fluid having ceramic powder

(75) Inventors: Sang-Ok Yoon, Gangwon-do (KR); Kwan-Soo Kim, Gangwon-do (KR); Shin Kim, Gangwon-do (KR); Yun-Han Kim, Gangwon-do (KR)

Correspondence Address: BACON & THOMAS, PLLC, 625 SLATERS LANE, FOURTH FLOOR, ALEXANDRIA, VA, 22314-1176, US

(73) Assignee: KANGNUNG NATIONAL UNIVERSITY INDUSTRIAL ACADEMY CORPORATION GROUP, Gangwon-do (KR)

(21) Appl. No.: 12/461,806

(22) Filed: Aug. 26, 2009

Related U.S. Application Data
(63) Continuation of application No. PCT/KR2008/001103, filed on Feb. 26, 2008.

(30) Foreign Application Priority Data
Feb. 26, 2007 (KR) 10-2007-0018915

(51) Int. Cl. C09K 3/14

(52) U.S. Cl. 51/298

(57) ABSTRACT

A water-based cutting fluid includes a water-soluble polymer dissolved in water and ceramic powder dispersed in the water. The cutting fluid further includes water glass. Further, the water-soluble polymer is one selected from a group consisting of polyvinyl alcohol (PVA), cellulose, methyl cellulose, carboxymethyl cellulose (CMC), starch, or a combination thereof.

### CROSS-REFERENCE(S) TO RELATED APPLICATION(S)

This application is a Continuation Application of PCT International Application No. PCT/KR2008/001103 filed on Feb. 26, 2007, which designated the United States.

### FIELD OF THE INVENTION

The present invention relates to a water-based cutting fluid having ceramic powder, and in particular, to an environmentally friendly water-based cutting fluid having ceramic powder with superior lubricity and cooling capability that is capable of being used as a substitute for cutting oil in cutting a metal and a nonmetal, such as ceramic, or during mechanical machining.

### BACKGROUND OF THE INVENTION

In general, mechanical machining of a metal, such as iron (Fe), aluminum (Al), or an alloy, is a method that is used to remove an unnecessary portion from a structure by a cutting tool. The mechanical machining has been widely used to cut the structure such that it has a desired shape, dimension, or surface.

In such mechanical machining, large friction occurs at a contact surface of the structure and the cutting tool. Then, the cutting tool may be burned by heat generated due to the friction, the machined surface of the structure may be roughened, and the shape of the structure or tool and dimensional accuracy may be degraded due to thermal expansion. In order to solve these problems, cutting oil or a lubricant is used during mechanical machining.

As the cutting oil, water-insoluble cutting oil and water-soluble cutting oil have been generally used. Examples of the water-insoluble cutting oil include cutting oil that is obtained by adding sulfur or chlorine to mineral oil. Examples of the water-soluble cutting oil include cutting oil that is obtained by adding soap or sulfate ester as an emulsifier and higher alcohol or fatty acid ester as a binder to oil, such as mineral oil.

The cutting oil, the cutting fluid, or the lubricant according to the related art is described in the following documents.

Korean Patent Application Laid-Open No. 10-2003-20800, entitled “combination system of low viscosity lubricant protection coating forming agent containing synthesized low molecular weight ceramic and low molecular weight ceramic film-forming heat exchanging conductor for maximizing combustion efficiency of internal combustion engine in motor, ship, or vehicle”, discloses a product for forming a lubricant and a film coating of an inner wall (cylinder) of an internal combustion engine with a specially processed material, and a combination system for the use of the product, thereby activating an internal combustion engine of a motor, a ship, or a vehicle and improving combustion efficiency.

Korean Patent Application Laid-Open No. 10-2000-76116, entitled “aqueous cutting fluid, aqueous cutting agent, and method of cutting hard and brittle material using the same”, which corresponds to Japanese Patent Application Laid-Open No. 11-349979, discloses an aqueous cutting fluid that includes cationic water-soluble resin having an amine value of 20 to 200 mgKOH/g, and at least one viscosity modifier selected from a group having inorganic bentonite, organic bentonite, and aqueous silica sol. In this case, the content of a nonvolatile matter of the viscosity modifier is 0.1 to 30% by weight with respect to the amount of a nonvolatile matter of the cationic water-soluble resin. In addition, the document also discloses an aqueous cutting agent that includes the aqueous cutting fluid and an abrasive grain. In this case, the content of the abrasive grain is 100 to 1000% by weight with respect to the amount of a nonvolatile matter of the aqueous cutting fluid.

Korean Patent Registration No. 10-0520714, entitled “aqueous composition, aqueous cutting fluid using the same, method for preparation thereof, and cutting method using cutting fluid”, corresponds to Japanese Patent Application Laid-Open No. 11-302681. This document discloses an aqueous cutting fluid that is obtained by dispersing abrasive grains in an aqueous composition. The aqueous composition includes a dispersion medium containing a hydrophilic alcohol compound, such as ethylene glycol, a lipophilic alcohol compound, such as propylene glycol, water, and silica colloid particles stably dispersed in the medium.

Korean Patent Registration No. 10-0494296, entitled “nonflammable water-based cutting fluid composition and nonflammable water-based cutting fluid”, corresponds to Japanese Patent Application Laid-Open No. 2003-82381. This document discloses a cutting fluid composition that includes polycarboxylic acid-based polymer compound having a weight average molecular weight of 1,000 to 200,000 and/or its salt in an amount of 5 to 45% by weight.

U.S. Pat. No. 5,976,695 discloses a composition that is formed by thermal spraying, which is used as an abrasive including metal powder and ceramic powder.

Japanese Patent Application Laid-Open No. 2005-113039, entitled “aqueous cutting fluid, aqueous slurry, and method of cutting cutting-resistant hard and brittle material”, discloses an aqueous cutting fluid that includes a water-soluble polymer having a structural unit of an amide bond and a polymer containing activated hydrogen. If necessary, the aqueous cutting fluid further includes a dispersing agent, an antirust agent, a lubricant, an anti-foaming agent, and a pH buffer agent as additives.

Japanese Patent Application Laid-Open No. 1998-330732, entitled “friction material composition and friction material using the same” discloses a friction material composition that contains 0.3 to 23% by weight of glassy carbon and 0.03 to 12% by weight of silicon carbide. A friction material is prepared by heating and pressing the friction material composition.

Among the cutting oil, the cutting fluids, or the lubricants according to the related art, in regards to the water-insoluble cutting oil, if a temperature rises during cutting, smoking or firing may occur. Accordingly, it is only used when a cutting temperature is low. In regards to the water-soluble cutting oil, it needs to be diluted with water to be used for mechanical machining, and thus it has inferior cooling capability.

In particular, the water-insoluble cutting oil or the water-soluble cutting oil can be repeatedly used. However, if a lot of time has passed, bacteria may be created, and the cutting oil may smell bad due to the bacteria or gas therefrom. In addition, if the waste cutting oil is discharged as it is, the environment may be polluted by a mineral oil component or an emulsifier in the cutting oil, which may adversely affect the human body. Accordingly, it takes a lot of cost and effort to process the waste cutting oil.

### SUMMARY OF THE INVENTION

It is, therefore, an object of the present invention to provide a water-based cutting fluid having ceramic powder that has low viscosity to permit better fluid flow when a metal or a nonmetal is cut, and has superior lubricity and cooling capability, thereby preventing a tool from being worn and thus increasing the lifespan of the tool.

It is another object of the present invention to provide a harmless and environmentally friendly water-based cutting fluid having ceramic powder that has no change in quality even if repeatedly used, prevents bacteria growth or smell due to microbe, and contains no environmental pollution material or smelly material.

In accordance with an aspect of the present invention, there is provided a water based cutting fluid for cutting work, including: a water-soluble polymer dissolved in water; and ceramic powder dispersed in the water.

### DETAILED DESCRIPTION OF THE EMBODIMENTS

Hereinafter, an embodiment of the present invention will be described in detail with reference to the accompanying drawings which form a part hereof.

A water-based cutting fluid in accordance with an embodiment of the present invention is obtained by dissolving a water-soluble polymer and dispersing ceramic powder in water. The cutting fluid composition is used for cutting work.

It should be noted that the term “cutting work” used herein is used in a broad sense as follows over this specification and the appended claims.

The meaning of “cutting work” includes cutting, turning, boring, or milling with a blade, and grinding, honing, lapping, semiconductor wafer polishing with grindstone particles, or rock drilling by a shield method. In addition, target material of the cutting work may be a metal, glass, ceramic, or plastic.

The cutting fluid may further include water glass.

Water glass is, not intended to limit the present invention, a sodium silicate aqueous solution. Instead of sodium silicate, lithium silicate or potassium silicate may be used.

The water-soluble polymer is preferably one selected from a group consisting of polyvinyl alcohol (PVA), cellulose, methyl cellulose, carboxymethyl cellulose (CMC), starch, or a combination thereof.

Polyvinyl alcohol is added to minimize the content of water glass, and to increase the lubricity of the water-based cutting fluid. Water glass (sodium silicate aqueous solution) has high lubricity. However, if it is left out for a long time, it may become hard, and thus the efficiency of the cutting performance is lowered. Therefore, it is preferable to minimize the content of water glass.

Carboxymethyl cellulose functions as a lubricant and a dispersing agent to increase dispersion stability or viscosity stability of ceramic powder, thereby preventing the ceramic powder (hard cake). Therefore, by adding carboxymethyl cellulose to the ceramic water-based cutting fluid, it is possible to delay or control sedimentation time thereof.

Water-soluble carboxymethyl cellulose is represented by Chemistry Formula I below. That is, a hydroxy group (—OH group) of cellulose is substituted with a hydrophilic sodium carboxymethyl group (CH2COONa) to be water-soluble. In addition, water-soluble carboxymethyl cellulose has hygroscopicity.

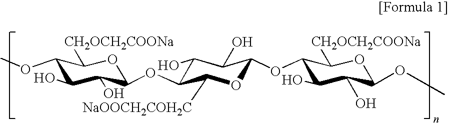

Chemical Structure of Carboxymethyl Cellulose (CMC)

When the concentration of the water-soluble polymer dissolved in the aqueous solution is high, viscosity is high, and the water-soluble polymer may be hardened when the aqueous solution is dried. When the concentration of the water-soluble polymer is low, lubricity may be degraded. Accordingly, it is necessary to dissolve the water-soluble polymer in the water-based cutting fluid with an appropriate amount. In accordance with an embodiment of the present invention, the content of the water-soluble polymer is preferably in a range of 1 to 30% by weight with respect to the amount of the water-based cutting fluid, and more preferably, in a range of 10 to 25% by weight.

The ceramic power dispersed in the cutting fluid may contain a single kind of powder or a plurality of kinds of powder having a plate shape, a spherical shape, or various shapes. As a primary component of an environmentally friendly ceramic water-based cutting fluid, the ceramic powder is preferably one selected from a group consisting of graphite, sericite, talc, kaolinite, fly ash, or a mixture of two or more of them. Accordingly, in the water-based cutting fluid in accordance with the embodiment of the present invention, since the ceramic powder has a plate shape or a spherical shape, a mutual sliding property is good and thermal conductivity is high. In addition, since heat generated during cutting is dissipated, the water-based cutting fluid is excellent in cooling capability. In accordance with the embodiment of the present invention, the ceramic powder may include stable ceramic or metal compound powder having a plate shape or a spherical shape, such as graphite, sericite, talc, kaolinite, or fly ash.

To increase the cooling capability and lubricity, the content of the ceramic powder is preferably in a range of 1 to 40% by weight with respect to the amount of the composition, and more preferably, in a range of 5 to 30% by weight.

In the water-based cutting fluid in accordance with the embodiment of the present invention, an additive may be mixed according to the purposes. The additive may be one selected from a group consisting of an antirust agent for preventing the tool or the structure from rusting, a gloss agent for putting a gloss on the surface of the structure during polishing, natural materials for increasing lubricity such as starch, a dispersing agent, an antiseptic agent, an antimicrobial agent, and an aromatic.

As the additive, a water-soluble product available on the market may be used. The content of the additive is not particularly limited, but it is preferably in a range of 0.1 to 2% by weight with respect to the amount of the composition.

Hereinafter, performance of the water-based cutting fluid will be described.

The water-based cutting fluid in accordance with the embodiment of the present invention can be used as a substitute for cutting oil in cutting a metal or a nonmetal. For example, the water-based cutting fluid is a suspension in which a single kind or a plurality of kinds of plate-shaped or spherical ceramic powder, such as graphite or sericite, is dispersed in the aqueous solution obtained by dissolving water-soluble polymer and/or water glass in water. As such, since ceramic or metal compound powder having high thermal conductivity is dispersed in the aqueous solution with an appropriate amount, heat generated during cutting work can be reduced.

The water-based cutting fluid in accordance with the embodiment of the present invention may be diluted 20 to 50 times with water according to the purposes. After used, the water-based cutting fluid may be processed by a general sewage treatment while the ceramic powder is removed. In this case, there is little adverse affect on the environment.

Examples of the metal or nonmetal cutting tool, which uses the water-based cutting fluid in accordance with the embodiment of the present invention, include a single-blade tool, such as a bite, a multiple-blade tool, such as a drill, a reamer, a milling cutter, a broach, a saw, a shank, and a grinding tool, such as a grindstone or grindstone particles. In addition, the cutting tool may include a formed turning tool having a cutting blade shape corresponding to a contour of the product to be cut. As the material for the cutting tool, for example, carbon tool steel, high speed steel, cast non-ferrous metal alloys, cemented carbides, ceramics (sintered oxides), diamond, and artificial grindstone particles may be exemplified.

Examples of the structure, which is subject to cutting with the water-based cutting fluid in accordance with the embodiment of the present invention, include metal structures, such as steel round bars, steel square bars, and steel hexagonal bars, and steel plates. Specifically, steel, such as rolled steel for general structural use, carbon steel and molybdenum steel plates, round steel for rivet, round steel for chain, rolled steel for welding structural use, hot rolled steel plates and strips, cold rolled steel plates and strips, carbon steel pipes for general structural use, carbon steel pipes for machine structural use, carbon steel pipes for ordinary piping, carbon steel pipes for general pressure use, carbon steel pipes for high pressure use, carbon steel pipes for high temperature service, alloy steel pipes for ordinary piping, low carbon steel wire rods, high carbon steel wire rods, carbon steel for machine structural use, nickel chromium steel, aluminum chromium molybdenum steel, stainless steel, and rolled steel for welding structural use, oxygen free copper, tough pitch copper, phosphorous deoxidized copper, copper-gold alloys, copper-zinc alloys, magnesium alloy die cast, white metals, titanium, titanium alloys may be exemplified. However, the present invention is not limited thereto.

The water-based cutting fluid in accordance with the embodiment of the present invention may be supplied to, for example, a pump for cutting oil of a round saw cutting machine, a table drilling machine, a lathe, or a rock drilling machine. In addition, it may be used in cutting round steel bars, boring, or manufacturing a flange surface. Furthermore, it may be used in cutting nonmetals, such as glass, ceramic, special potteries, or reinforced plastics, or in rock drilling by a shield method.

The water-based cutting fluid in accordance with the embodiment of the present invention can prevent any damage, for example, damage of the cutting tool due to temperature, destroy of a blade, and steady abrasion of the blade. Since the cutting fluid includes water and stable ceramic powder, it has low viscosity to permit better fluid flow and no change in quality, compared with the known cutting oil that contains mineral oil as a base material. In addition, it is excellent in cooling capability and lubricity, thereby reducing frictional heat between the structure and the tool. Therefore, if the ceramic water-based cutting fluid in accordance with the embodiment of the present invention is used, the lifespan of the tool is increased. Furthermore, since it does not contain any organic matters or oily components, which causes being rotten, it has no problem in waste disposal after used.

In order to estimate the characteristics of the water-based cutting fluid in accordance with the embodiment of the present invention, a solution of undiluted water glass and a water-soluble polymer is added to 1 liter water in an amount of 2 to 30% by weight based on the composition ratio shown in Table 1 and mixed for 1 to 2 hours, thereby preparing a lubricant aqueous solution. Next, ceramic powder is added based on the composition ratio and stirred for 6 to 12 hours, thereby preparing a ceramic water-based cutting fluid. Next, the ceramic water-based cutting fluid is blended in water to dilute 20 to 30 times, and the characteristics thereof are estimated.

TABLE 1

| | | | Water-Soluble | | | | | |
|---|---|---|---|---|---|---|---|---|
| | | Water | Polymer | | Ceramic Powder | | | |
| No. | Water | glass | PVA | CMC | Graphite | Sericite | Talc | Homogeneity |
| 1 | 40 | 10 | 10 | 10 | 30 | 0 | 0 | x |
| 2 | 50 | 10 | 2 | 8 | 25 | 5 | 0 | ∘ |
| 3 | 50 | 7 | 3 | 0 | 30 | 5 | 5 | x |
| 4 | 50 | 10 | 5 | 10 | 20 | 0 | 5 | Δ |
| 5 | 65 | 10 | 0 | 10 | 20 | 5 | 0 | ∘ |
| 6 | 65 | 15 | 0 | 15 | 5 | 5 | 5 | x |
| 7 | 60 | 10 | 10 | 0 | 15 | 5 | 0 | x |
| 8 | 55 | 10 | 0 | 10 | 20 | 0 | 5 | ∘ |
| 9 | 65 | 5 | 0 | 10 | 10 | 5 | 5 | Δ |
| 10 | 85 | 5 | 0 | 5 | 5 | 0 | 0 | x |

Referring to Table 1, when ten cutting fluids having different composition ratios are prepared and estimated, if the content of the water-soluble polymer and the water glass is more than 30% by weight with respect to the amount of the composition, viscosity is high to cause bad fluid flow, and when being dried, the cutting fluid is hardened. In addition, when the content of the ceramic powder is more than 40% by weight with respect to the amount of the composition, the amount of the aqueous solution is small, and thus it is difficult to perform stirring and mixing and thus to prepare the composition.

The prepared ceramic water-based cutting fluids are diluted 20 to 30 times with water according to the use conditions, and then the states of the fluids are estimated. From the estimation result, it can be seen that the cutting fluids containing both water glass and water-soluble methyl cellulose exhibit stable dispersion characteristics.

The compositions 2, 5, and 8 in Table 1 are used in actual cutting work and estimated as follows.

The compositions 2, 5, and 8 are supplied to a machining center (TSUNE 70GL) with a specific saw blade (HSS 265×120Z) under the same conditions of rotation speed and depth of tool.

The comparison result of the compositions 2, 5, and 8 and the known cutting oil (EML-110, Emulsion type) is shown in Table 2.

TABLE 2

| Product | Dilution | Rotation Speed | Depth of Tool | Cutting Time | Cutting Quantity | Cut Surface |
|---|---|---|---|---|---|---|
| Name | Ratio | (RPM) | (mm) | (SEC) | (ea) | State |
| EML-110 | 8% | 38 | 113~115 | 16.2 | 5000 | Good |
| Composition 2 | 5% | 38 | 115 | 15.5 | 5288 | Good |
| Composition 5 | 5% | 38 | 115 | 15.5 | 5239 | Good |
| Composition 8 | 5% | 38 | 115 | 15.5 | 5137 | Good |

As apparent from Table 2, in regards to the compositions 2, 5, and 8, the cutting quantity based on the cutting time is larger than that of the existing cutting oil (EML-110, Emulsion type), and the cut surface states are better. In addition, in regards to the compositions 2, 5, and 8, there is no case in which an organic matter is volatilized due to heat generated during a cutting operation. Therefore, it can be seen that they do not adversely affect the human body, and odor free.

As described above, the water-based cutting fluid in accordance with the embodiment of the present invention has low viscosity to permit better fluid flow when a metal or a nonmetal is cut, and is excellent in lubricity and cooling capability. Accordingly, the abrasion of the tool is prevented, thereby increasing the lifespan of the tool. And, it avoids quality degradation even if repeatedly used. In addition, since oil is not used, bacteria growth or smell due to microbe is prevented. Furthermore, since it contains no environmental pollution material or smelly material, it is harmless to the human body and environmentally friendly.

While the invention has been shown and described with respect to the embodiments, it will be understood by those skilled in the art that various changes and modifications may be made without departing from the scope of the invention as defined in the following claims.

What is claimed is:

1. A water based cutting fluid for cutting work, comprising:
a water-soluble polymer dissolved in water; and
ceramic powder dispersed in the water.

2. The cutting fluid of claim 1, further comprising water glass.

3. The cutting fluid of claim 1, wherein the water-soluble polymer is one selected from a group consisting of polyvinyl alcohol (PVA), cellulose, methyl cellulose, carboxymethyl cellulose (CMC), starch, or a combination thereof.

4. The cutting fluid of claim 2 or 3, wherein the content of the water glass and the water-soluble polymer is 1 to 30% by weight with respect to the amount of the cutting fluid.

5. The cutting fluid of claim 3, wherein the content of the water glass and the water-soluble polymer is 1 to 30% by weight with respect to the amount of the cutting fluid.

6. The cutting fluid of claim 1, wherein the ceramic powder has one of a plate shape, a spherical shape, and a hybrid shape including plate and spherical shapes.

7. The cutting fluid of claim 1, wherein the ceramic powder is one selected from a group consisting of graphite, sericite, talc, kaolinite, fly ash, or a combination thereof.

8. The cutting fluid of claim 1, wherein the content of the ceramic powder is 5 to 30% by weight with respect to the amount of the cutting fluid.

9. The cutting fluid of claim 5, wherein the content of the ceramic powder is 5 to 30% by weight with respect to the amount of the cutting fluid.

10. The cutting fluid of claim 6, wherein the content of the ceramic powder is 5 to 30% by weight with respect to the amount of the cutting fluid.

11. The cutting fluid of claim 1, wherein, as an additive, one selected from a group consisting of a dispersing agent, an antirust agent, an antiseptic agent, an antimicrobial agent, a gloss agent, or a combination thereof is mixed in the cutting fluid.

12. The cutting fluid of claim 8, wherein the content of the additive is 0.1 to 2% by weight with respect to the amount of the cutting fluid.

13. A water based cutting fluid for cutting work, comprising:
a water glass dissolved in water;
a water-soluble polymer dissolved in the water; and
ceramic powder containing graphite dispersed in the water, wherein the content of the ceramic powder is 5 to 30% by weight with respect to the amount of the cutting fluid.
